(19) United States
(12) Patent Application Publication
(10) Pub. No.: US 2006/0215916 A1
(43) Pub. Date: Sep. 28, 2006

(54) Decoding device, distribution estimation method, decoding method and programs thereof

(75) Inventor: Shunichi Kimura, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/168,920

(22) Filed: Jun. 29, 2005

(30) Foreign Application Priority Data
Mar. 25, 2005 (JP) 2005-088229

(51) Int. Cl. G06K 9/36; G06K 9/46; G06K 9/00

(52) U.S. Cl. 382/233; 382/168

(57) ABSTRACT

A distribution estimation method that estimates a distribution of signal for each of a plurality of components, includes, in estimating a distribution of a target component, approximating distribution data indicating a distribution of signal of other component by a function regarding the component, and calculating distribution data for the target component by the function based on the approximated process.

### BACKGROUND OF THE INVENTION

1. Field of the Invention

The present invention relates to a decoding device that decodes the coded data generated through an encoding process. More particularly, this invention relates to a decoding device which decodes the coded data generated through an encoding process with quantization of data by making the inverse quantization.

2. Description of the Related Art

For instance, JP-A-2004-80741 discloses a method for estimating a deterioration in the image quality caused by the compression encoding by presuming a probability density function of transformed coefficient for the original image from a frequency distribution of quantization index.

Also, ITU-T recommendation T.81 discloses the JPEG standard.

Also, ITU-T recommendation T.800 discloses the JPEG2000 standard.

### SUMMARY OF THE INVENTION

The invention provides a distribution estimation device that estimates a distribution of original data before quantization more appropriately.

According to an aspect of the present invention, a distribution estimation method that estimates a distribution of signal for each of a plurality of components, includes, in estimating a distribution of a target component as a processing object, approximating distribution data indicating a distribution of signal for other component with a function regarding the component, and calculating distribution data for the target component employing the function based on the approximated process.

According to another aspect of the present invention, a decoding method includes, in estimating a distribution of a target component as a processing object, approximating distribution data indicating a distribution of signal for other component with a function regarding the component, calculating distribution data for the target component employing the function based on the approximated process, calculating a inverse quantized value employing the calculated distribution data for the target component, and generating decoded data employing the calculated inverse quantized value.

According to another aspect of the present invention, a decoding device includes a first distribution generation unit that generates distribution data indicating a distribution of data before quantization for any of component based on a frequency distribution of quantization index, a second distribution generation unit that generates distribution data for other component based on the distribution data generated by the first distribution generation unit, and a inverse quantized value generation unit that generates a inverse quantized value corresponding to a quantization index based on the distribution data generated by the first distribution generation unit or the distribution data generated by the second distribution generation unit.

According to another aspect of the present invention, a storage medium readable by a computer, the storage medium storing a program of instructions executable by the computer to perform a function for estimating a distribution of signal for each of a plurality of components, the function includes the steps of, in estimating a distribution of a target component as a processing object, approximating distribution data indicating a distribution of signal for other component with a function regarding the component, and calculating the distribution data for the target component employing the function based on the approximated process.

The distribution estimation device of the invention can estimate the distribution of original data before quantization more appropriately.

### BRIEF DESCRIPTION OF THE DRAWINGS

Embodiments of the present invention will be described in detail based on the following figures, wherein:

FIGS. 1A to 1C are diagrams for explaining a quantization process in accordance with a transformation encoding method;

FIGS. 2A and 2B are diagrams for schematically explaining a distribution estimation process;

FIGS. 3A and 3B are diagrams for exemplifying a distribution of a value;

FIG. 4 is a flowchart of a distribution estimation process according to a first embodiment of the invention;

FIG. 5 is a flowchart of a distribution estimation process in a modified example of the invention;

FIG. 6 is a diagram for exemplifying a functional configuration of a decoding program 5 to which the distribution estimation method of the invention is applied;

FIG. 7 is a diagram for explaining a distribution estimation part 520 (FIG. 6) in more detail;

FIG. 8 is a diagram for explaining the distribution estimation process by a non-zero transformed coefficient distribution estimation part 524;

FIG. 9 is a flowchart showing a decoding process by a decoding program 5 (FIG. 6); and

FIG. 10 is a diagram showing a hardware configuration of a distribution estimation device 2 and a decoding device 3.

### DETAILED DESCRIPTION OF THE INVENTION

First of all, to help understanding this invention, the background and the outline of the invention will be described below.

For the image data, voice data, and moving picture data, etc., it is common to reduce the amount of data by compressing it, and to hold or transmit the image data, because the amount of data is huge. For instance, like the image data when the color manuscript or photograph is made electronic by an image scanner, or the image data when the photograph of scenery is taken by a digital camera, the multi-valued image data can be compressed into a smaller amount of data using the non-reversible encoding methods such as the JPEG method or the JPEG2000 method.

The contents of the JPEG method and the JPEG2000 method have been described respectively in detail in the ITU-T recommendation T.81 and ITU-T recommendation T.800.

There is a problem that the encoding distortion occurs when the non-reversible encoding process is performed. In the non-reversible encoding process, an input image signal is once linearly transformed and the transformed signal is quantized to compress image data at high efficiency.

For instance, the transformed signal has a distribution like a Laplace or Gaussian distribution.

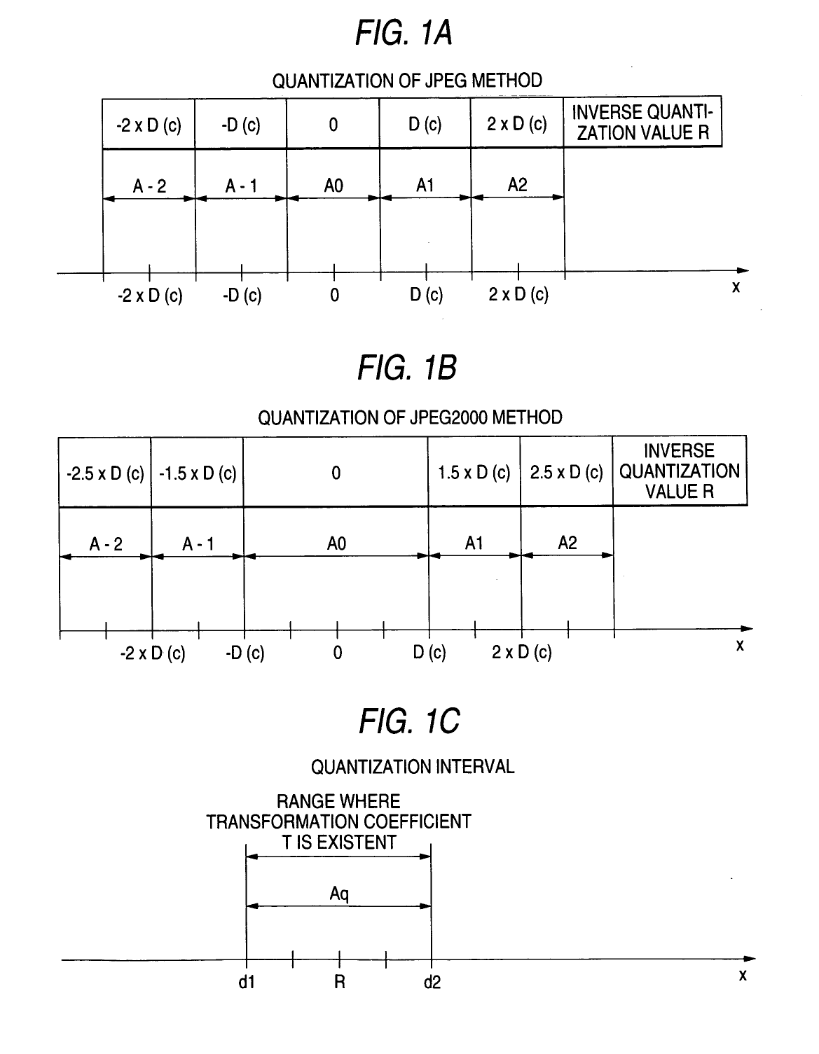

The quantization involves dividing the signal into plural intervals, and giving an index q to a signal within an interval q, as shown in FIGS. 1A to 1C. This index q is hereinafter referred to as a quantization index. The quantization interval (interval for quantization) as shown in FIG. 1A accords to the JPEG method, and the quantization interval (interval for quantization) as shown in FIG. 1B accords to the JPEG2000 method.

A decoder inputs the index quantized in the above manner and restores a transformed signal (transformation coefficient T) by making the inverse quantization. At this time, the transformation coefficient T of original data is distributed in a range from d1 to d2, as shown in FIG. 1C, but because the restored transformation coefficient signal R (inverse quantized value) and the coefficient signal T of original image are different, there may occur a distortion on the image.

In this invention, it is noted that “a probability density function of original data (transformation coefficient of original image in this example) is estimated from the frequency distribution of quantization index”.

For the technique for appropriately estimating the probability density function, the following two kinds of applications are conceived.

(1) Technique for reducing the distortion of data compression

(2) Technique for estimating the distortion of data compression

First of all, these two kinds of applications will be described below.

(Technique for Reducing the Distortion of Image Compression)

To reduce an encoding distortion occurring by image encoding such as JPEG method or JPEG2000 method, the parameters for decreasing the compression efficiency at the time of encoding may be selected.

However, in this case, there is a problem that the encoding efficiency is lower, and the amount of data is increased.

Also, if the image quality of already encoded data tries to be increased, the method of decreasing the compression efficiency can not be employed.

Thus, another technique for resolving the image distortion at the time of decoding is needed. For example, there is another technique for resolving the image distortion of a decoded image by making the distribution of inverse quantized transformation coefficients closer to the distribution of transformation coefficients of original image. For example, the probability density function of transformation coefficient of original image is estimated from the frequency distribution of quantization index, and the random number is generated according to the distribution of estimated probability density function.

(Technique for Estimating the Distortion of Image Compression)

Also, a technique for estimating a deterioration in the image quality due to compression encoding by estimating the probability density function of transformation coefficient of original image from the frequency distribution of quantization index was disclosed in JP-A-2004-80741.

With this technique, the probability density function f(x) of transformed signal of original image is estimated from the frequency distribution of quantization index.

Suppose that the inverse quantized value of quantization index q is R(q). Also, suppose that the range of transformed signal with quantization index q is Min(q) to Max(q).

At this time, the signal with quantization index q must be distributed from Min(q) to Max(q), but has a value of R(q) due to image compression. Thus, in JP-A-2004-80741, the distortion S(q) given to the signal with quantization index q is estimated in accordance with the following expression (formula 1).

$$[ Formula 1 ] \\ S ( q ) = {\int }_{Min ( q )}^{Max ( q )} {( x - R ( q ) )}^{2} ⅆ x \qquad ( Expression 1 )$$

Also, the total distortion is calculated by adding S(q) for all the indexes q (in practice, there are plural transformation coefficients (e.g., 64 transformation coefficients in the JPEG method), and the distortion in the entire image is estimated by adding the distortion for the transformation coefficients).

The techniques for estimating the probability density function are available in the above manner. Accordingly, it is important to appropriately estimate the probability density function.

In the following, the techniques for estimating the probability density function will be examined.

(Preparations)

First of all, suppose that the frequency distribution of quantization index is h(q). That is, suppose that the number of quantization indexes with the value q is h(q). Also, suppose that the minimum value of q is qmin, and the maximum value is qmax.

Also, suppose that H(q) is a normalized histogram. Herein, normalization means that the total sum of H (q) is equal to 1. That is, the normalized histogram is defined by the following expression (formula 2).

$$[ Formula 2 ] \\ H ( q ) = \frac{h ( q )}{{\sum }_{q = q min}^{q max} h ( q )} \qquad ( Expression 2 )$$

Also, suppose that the quantization value of quantization index q is R(q), and the quantization step size (i.e., width of each quantization interval as shown in FIGS. 1A to 1C) is D.

(First Estimation Method)

First of all, a first estimation method as disclosed in JP-A-2004-80741 will be described below.

In JP-A-2004-80741, it is expected that the variance of inverse quantized value and the variance of original continuous signal are almost equivalent, whereby σ is estimated. The variance of inverse quantized value is computed in the following manner.

First of all, the mean value μ of R(q) is calculated in accordance with the expression 3 (formula 3).

$$[ Formula 3 ] \\ μ = {\sum }_{q = q min}^{q max} R ( q ) H ( q ) \qquad ( Expression 3 )$$

Next, employing the mean value μ, the variance σ² of R(q) is calculated in accordance with the expression 4 (formula 4).

$$[ Formula 4 ] \\ {σ}^{2} = {\sum }_{q = q min}^{q max} {( R ( q ) - μ )}^{2} H ( q ) \qquad ( Expression 4 )$$

With the estimation method as disclosed in JP-A-2004-80741, a Laplace distribution in which the standard deviation σ is obtained by the above formula is an estimated transformation coefficient distribution.

With the first estimation method as described above, when all the R(q) values are zero, viz., the quantization step size is large (or the signal size is small), and all the quantization indexes are zero, the variance can not be obtained (or the estimated value becomes zero).

Thus, the following second estimation method involves arranging the standard deviations of transformation coefficients two-dimensionally in the order of frequencies, and acquiring the standard deviation of transformation coefficient in which the estimated value is zero.

(Second Estimation Method)

A second estimation method will be described below.

First of all, it is supposed that the non-zero transformation coefficient is the transformation coefficient in which none of the quantization indexes of a certain transformation coefficient is zero. It is also supposed that the zero transformation coefficient is the transformation coefficient in which all the quantization indexes of a certain transformation coefficient kind are zero.

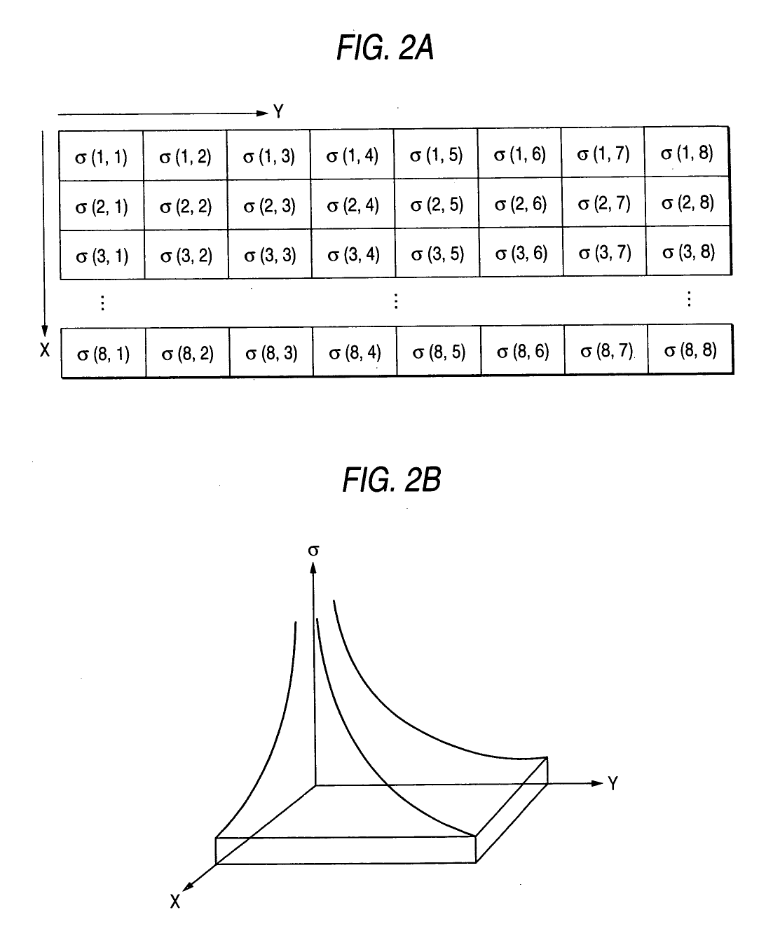

FIGS. 2A and 2B are diagrams for schematically explaining the second estimation method.

For the second estimation method, a specific example of the decoding process by the JPEG method is given. With the JPEG method, the transformation coefficients are arranged in a two-dimensional 8×8 matrix, as shown in FIG. 2A. It is supposed that the standard deviations σ are arranged two-dimensionally from (1,1) component of DCT to (8,8) component. Thus, the standard deviations σ are arranged on the two dimensional plane. That is, the σ value of (x,y) component is denoted as σ(x,y).

σ(1,1) is the C value of DC component, and σ(8,8) is the σ value of transformation coefficient indicating the AC component in the highest frequency range. Herein, estimation of σ for the DC component is not made.

With the second estimation method, σ(x, y) is considered as a function on the xy plane, as shown in FIG. 2B. Employing σ already obtained, this function is decided, and another σ is estimated. Herein, the function is approximated by a two-dimensional exponential function as shown in FIG. 2B. That is,

[Formula 5]
σ(x,y)=Cexp(−ax−by) (Expression 5)

In the formula 5, C, a and b are the parameters indicating the shape of an approximate function for σ(x,y). After acquiring these parameters, σ not obtained is computed, employing the formula 5.

Herein, σ(x,y) already obtained is made σ(x(u),y(u)). However, u=1, 2, . . . ,U, and (x(u),y(u)) is the coordinates of σ already obtained.

Also, because all the quantization indexes are zero, a not obtained is made σ(x(v),y(v)). However v=1, 2, . . . ,V, and U+V=63.

First of all, C, a and b are decided employing σ(x(u),y(u)) (u=1, 2, . . . U).

As the preparation, both sides of the formula 5 are made logarithm.
log σ(x,y)=log C−ax−by

σ(x(u), y(u)) is substituted in this expression. That is,
log σ(x(u),y(u))=log C−ax(u)−by(u),

where u=1, 2, . . . U. Practically, the above expression is the matrix operation as shown in the expression (formula 6).

$$[ Formula 6 ] \\ ( \begin{matrix}- x ( 1 ) & - y ( 1 ) & 1 \\ - x ( 2 ) & - y ( 2 ) & 1 \\ ⋯ & ⋯ & ⋯ \\ - x ( U ) & - y ( U ) & 1\end{matrix} ) ( \begin{matrix}a \\ b \\ log C\end{matrix} ) = ( \begin{matrix}log σ ( x ( 1 ) , y ( 1 ) ) \\ log σ ( x ( 2 ) , y ( 2 ) ) \\ \\ log σ ( x ( U ) , y ( U ) )\end{matrix} ) \qquad ( Expression 6 )$$

The expression (formula 6) can be solved by a method of least square. If the expression (formula 6) is solved, a, b and C are obtained.

Then, employing the obtained a, b and C,
σ(x(v),y(v))=Cexp(−ax(v)−by(v))
and σ not obtained is estimated.

In this manner, with the second estimation method, a, b and C are calculated based on the σ values obtained, and the σ value not obtained is calculated employing the calculated a, b and C.

(First Problem With the Estimation Method)

When a, b and C are obtained employing the formula 6, it is required that the rank of a matrix M

$$[ Formula 7 ] \\ M = ( \begin{matrix}- x ( 1 ) & - y ( 1 ) & 1 \\ - x ( 2 ) & - y ( 2 ) & 1 \\ ⋯ & ⋯ & ⋯ \\ - x ( U ) & - y ( U ) & 1\end{matrix} ) \qquad ( Expression 7 )$$

in the formula 6 is greater than or equal to 3. That is, if the rank is less than 3, the above formula can not be solved.
(Second Problem With the Estimation Method)

The actual distribution of standard deviation is not matched with the exponential distribution as shown in the formula 5, so that the accurate estimation is not made.

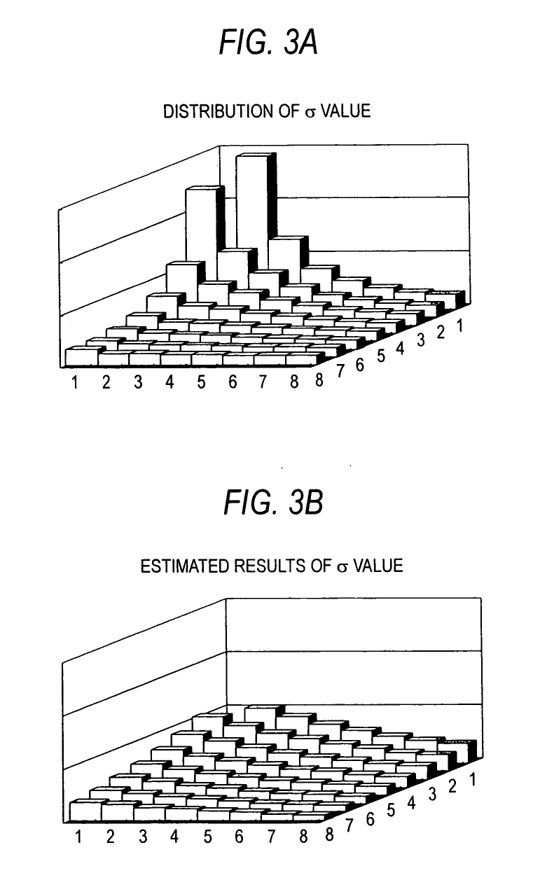

For example, FIG. 3A is a diagram showing the values of standard deviation along the two-dimensional frequency axes by measuring the value of standard deviation of each DCT coefficient on the actual image. The length of each bar graph corresponds to the value of standard deviation. The small value along the xy axes indicates the coefficient of low frequency.

FIG. 3B is a diagram showing the results of estimating the value of standard deviation based on the parameters of the formula 5 that are decided to be best matched with the σ value of FIG. 3A.

It will be found that the error is larger especially in the low frequency portion, as seen in FIGS. 3A and 3B.

Thus, in the light of the above-mentioned problems, the distribution estimation device 2 of this embodiment estimates the standard deviation of coefficient value for which the standard deviation is not estimated, based on the coefficient values of standard deviation already estimated, in which it is possible to

(1) make estimation even if the rank of the matrix M is less than 3, and

(2) implement accurate estimation.

### EXAMPLES

The distribution estimation device 2 of this embodiment will be more specifically described below. In the following, the standard deviation of (x,y) component is denoted as σ(x,y).

In this embodiment, σ(1,2) and σ(2,1) of low frequency components are not substituted in the formula 6 to calculate the formula 6.

However, since the rank of the matrix M may be possibly decreased in this manner, σ(1,2) and σ(2,1) may be substituted in the formula 5, depending on the rank, to estimate the parameters.

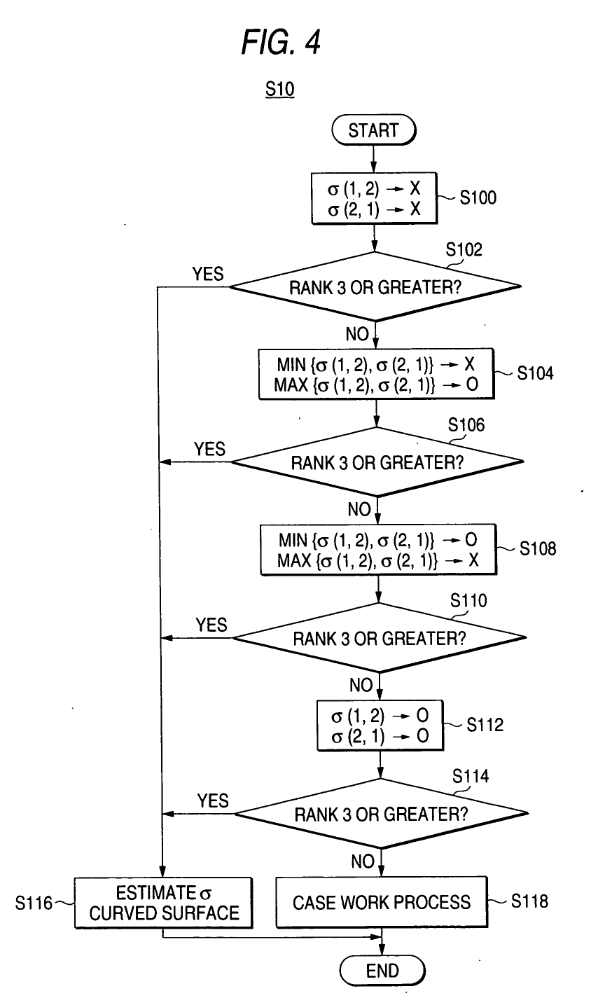

FIG. 4 is a flowchart of this embodiment.

In FIG. 4, “σ(x,y)→×” means that σ(x,y) is not included in the computation of the formula 6. Also, “σ(x,y)→ο” means that σ(x,y) is included in the computation of the formula 6. Unless specifically noted, σ(x,y) is always included in the computation of the formula 6.

Also, “max{A,B}→×” means that larger A or B is not included in the computation of the formula 6. Also, “max{A,B}→ο” means that larger A or B is included in the computation of the formula 6. Similarly, “min{A,B}→×” means that smaller A or B is not included in the computation of the formula 6. Also, “min{A,B}→ο” means that smaller A or B is included in the computation of the formula 6.

Also, the “estimation of a curved surface” indicates the computation of the formula 6.

As shown in FIG. 4, the distribution estimation device 2 firstly leaves both σ(1,2) and σ(2,1) out of consideration (S100).

If the rank is less than 3 (S102: No), the distribution estimation device 2 restores only one of σ(1,2) and σ(2,1) in the formula 6 (S104). It is optional which of σ(1,2) and σ(2,1) is restored, but the larger value is firstly restored in this example.

On the other hand, if the rank is greater than or equal to 3 (S102: Yes), the distribution estimation device 2 goes to processing at step S116.

If the larger σ value is restored and the rank is less than 3 (S106: No), the distribution estimation device 2 excludes the larger σ value and restores the smaller σ value (S108).

On the other hand, if the rank is greater or equal to 3 as a result of restoring the larger σ value (S106: Yes), the distribution estimation device 2 goes to processing at step S116.

If the smaller σ value is only restored and the rank is less than 3 (S110: No), the distribution estimation device 2 restores both σ values (S112).

On the other hand, if the rank is greater or equal to 3 as a result of restoring the smaller σ value alone (S110: Yes), the distribution estimation device 2 goes to processing at step S116.

If the rank is still less than 3 after restoring both σ values (S114: No), the distribution estimation device 2 makes a case work process (S118) as will be described later. Each case corresponds to either (state 1) in which any other coefficients than σ(1,2) and σ(2,1) are zero, or (state 2) in which non-zero coefficients exist in one row or column alone.

On the other hand, if the rank is greater or equal to 3 as a result of restoring both σ values (S114: Yes), the distribution estimation device 2 goes to processing at step S116.

At S116, the distribution estimation device 2 calculates the parameters a, b and C, employing the formula 6.

(Case Work Process)

The case work process (S118) will be described below.

(1) Where σ(1,2)≠0 and σ(2,1)≠0, other σ(i,j)=0 (case 1)

The distribution estimation device 2 presets the default values of parameters a and b in the formula 5 (default value a′ is decided in this example), and decides the value of C assuming the symmetry, in which the values of σ(1,2) and σ(2,1) multiplied by α (α is less than or equal to 1) are used. That is, the distribution estimation device 2 computes C by altering the formula 5 as follows.
Cexp(−3a′)=α(σ(1,2)+σ(2,1))/2

Also, the distribution estimation device 2 calculates the σ value by the following expression, employing C calculated in the above manner.
σ(u,v)=Cexp(−a′u−a′v)
(2) Where only one of σ(1,2) and σ(2,1) is non-zero, and all other σ(i,j) are 0

The distribution estimation device 2 decides the value of C, employing the preset coefficients a and b, in which the values of σ(1,2) and σ(2,1) multiplied by α (α is less than or equal to 1) are used.

The distribution estimation device 2 decides the value of C one-dimensionally, and also decides the coefficients in other rows or columns to be symmetrical. That is, the distribution estimation device 2 obtains the value of C employing Cexp(−3a′)=ασ(1,2), or Cexp(−3a′)=ασ(2,1).

The distribution estimation device 2 finally obtains the standard deviations of other transformation coefficients (zero transformation coefficients) with σ(u,v)=Cexp(−a′u−a′v).

(3) Where non-zero coefficient exists in one row or column alone

When there are two or more non-zero coefficients other than c(1,2) and a(2,1), the distribution estimation device 2 decides the value of C, and the value of a or b, one-dimensionally with “σ(1,2)→x” and “σ(2,1)→x”. The distribution estimation device 2 also decides the coefficients in other rows or columns to be symmetrical. That is, the distribution estimation device 2 sets b=a when a is decided, or a=b when b is decided.

For example, assume that the non-zero row is i. If σ(i,x1), σ(i,x2), . . . , σ(i,xn) are non-zero, the distribution estimation device 2 obtains the parameter a and C by solving the following expression (formula 8).

$$[ Formula 8 ] \\ ( \begin{matrix}- i - {x}_{1} & 1 \\ - i - {x}_{2} & 1 \\ ⋯ & ⋯ \\ - i - {x}_{n} & 1\end{matrix} ) ( \begin{matrix}a \\ log C\end{matrix} ) = ( \begin{matrix}log σ ( i , {x}_{1} ) \\ log σ ( i , {x}_{2} ) \\ ⋯ \\ log σ ( i , {x}_{n} )\end{matrix} ) \qquad ( Expression 8 )$$

Though the non-zero coefficient occurs in the row in the above case, the non-zero coefficient may also occur in the column. The distribution estimation device 2 finally obtains the standard deviations of other transformation coefficients (zero transformation coefficients) by the following expression.
σ(u,v)=Cexp(−au−av)
(4) Other cases

The distribution estimation device 2 ends the process with the zero transformation coefficients being zero.

In this manner, the distribution estimation device 2 of this embodiment can estimate the a values (i.e., distribution of original data before quantization) corresponding to the zero transformation coefficients, even if the rank of the matrix M is less than 3.

Also, this distribution estimation device 2 can estimate the a values (i.e., distribution of original data before quantization) more accurately.

### Modified Example 1

A modified example of this embodiment will be described below.

Though in the above embodiment two coefficient values σ(1,2) and σ(2,1) are not included in the computation of the expression (formula 6), the coefficient values not included in the computation are not limited thereto.

Thus, the distribution estimation device 2 in a first modified example excludes the coefficient belonging to a preset group G among a group of coefficients (x, y) from the computation of the equation (formula 6), as shown in FIGS. 2A and 2B. In this case, if the rank is greater than or equal to 3 even after all the coefficients belonging to the group G are excluded, the operation is directly possible. Also, if the rank is less than 3, the coefficients are restored one by one in the computation of the expression (formula 6), like the above embodiment, so that the rank may be greater than or equal to 3.

The group G may be defined such as G={(x,y)|(1,2) (2,1) (2,2) (1,3) (3,1) (3,2) (2,3)}, for example.

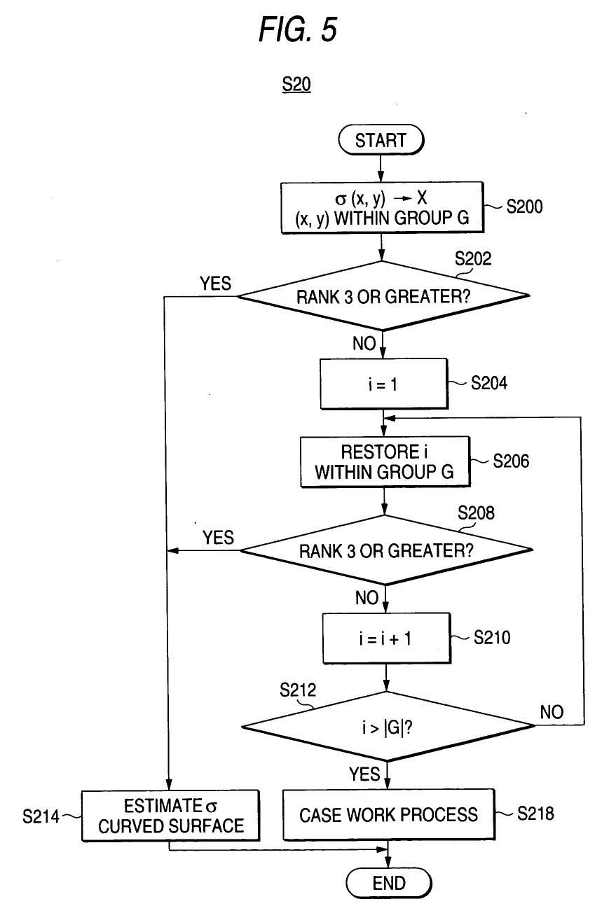

FIG. 5 is a flowchart of the first modified example.

In the flowchart of FIG. 5, a process of “i coefficients of the group G being included in the computation” is indicated by one step, but the operation of taking out i coefficients from the group G may be repeatedly tried to cover all the instances. Also, the processing at S118 as shown in FIG. 5 is almost equivalent to that as shown in FIG. 4.

As shown in FIG. 5, the distribution estimation device 2 leaves the a values belonging to the group G out of consideration (S200).

If the rank is less than 3 (S202: No), the distribution estimation device 2 sets i=1 (S204), and restores i σ values among the σ values belonging to the group G in the expression (formula 6) (S206). The distribution estimation device 2 of this example selects i σ values belonging to the group G according to a prescribed order of priority and restores the selected σ values, but the operation of taking out i coefficients from the group G may be repeatedly tried for all the instances.

On the other hand, if the rank is greater than or equal to 3 (S202: Yes), the distribution estimation device 2 goes to processing at step S214.

If the rank is less than 3 after restoring i σ values (S208: No), the distribution estimation device 2 increments the i value by one (S210).

On the other hand, if the rank is greater than or equal to 3 as a result of restoring i σ values (S208: Yes), the distribution estimation device 2 goes to processing at S214.

If the i value is beyond the number of σ values belonging to the group G, the distribution estimation device 2 proceeds to processing at step S118, or if not, returns to processing at S206.

At S214, the distribution estimation device 2 calculates the parameters a, b and c, employing the expression (formula 6).

Regarding the correctness of arithmetical operation as described above, the numerical values are given below.

(Mean error of results in this modified example)/(Mean error where σ(1,2) and σ(2,1) are included in estimation) was computed. This ratio was 0.849.

It can be found that the performance is increased by about 15%.

### Modified Example 2]

Though in the above embodiment, part of σ(x,y) are not included in the computation, a second modified example is provided with an intermediate characteristic between an instance where part of σ(x,y) are completely included in the computation and an instance where they are not completely included in the computation by multiplying a certain factor. In other words, the distribution estimation device 2 of this modified example decreases a contribution ratio of part of σ(x,y) to the distribution estimation by multiplying part of σ(x,y) by a weight factor α.

For example, the coefficient a α (0<α<1) is prepared, and the distribution estimation device 2 multiplies σ(1,2) and σ(2,1) by the coefficient α, and calculates the parameters a, b and C, employing σ(1,2) and σ(2,1) multiplied by the coefficient α, and their σ values. That is,
σ′(1, 2)=α×σ(1, 2)
σ′(2,1)=α×σ(2,1)
The distribution estimation device 2 creates the matrix M, employing σ′(1,2) and σ′(2,1), instead of σ(1,2) and σ(2,1), and obtains σ for other zero coefficients.

Herein, in the above embodiment, it is desired that the σ estimation function decreases monotonically in terms of x and y, because the exponential distribution is assumed. Thus, the distribution estimation device 2 of this modified example checks whether
σ′(1,2)>σ(1,3)
σ′(1,2)>σ(2,2)
σ′(1,2)>σ(2,3)
σ′(2,1)>σ(3,1)
σ′(2,1)>σ(2,2)
σ′(2,1)>σ(3,2)
and adjusts the value of coefficient α so that the σ value (σ′) multiplied by the coefficient α and other σ values decrease monotonically.

That is, the distribution estimation device 2 performs the arithmetical operation without multiplication of α, if the above expressions do not hold.

### Second Embodiment

A second embodiment in which the distribution estimation method as described in the first embodiment is applied to the decoding process will be described below.

In this embodiment, a specific example of decoding the coded data encoded by the JPEG method is given below.

[Decoding Program]

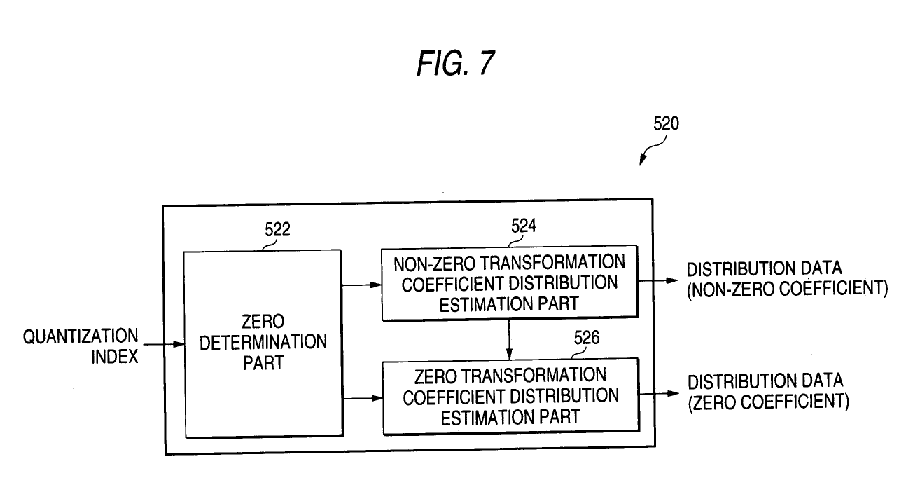

FIG. 7 is a diagram exemplifying the functional configuration of a decoding program 5 to which the distribution estimation method of the invention is applied.

As illustrated in FIG. 7, the decoding program 7 has an entropy decoder 40, an inverse quantization part 50 and a inverse transformation part 60.

Also, the inverse quantization part 50 includes a inverse quantized value estimation part 500, a distribution estimation part 520, an expected value estimation part 540, a random number generator 560, a correction part 580 and a inverse quantized value output part 590.

In the decoding program 5, the entropy decoder 40 entropy decodes the input coded data and outputs the decoded data to the inverse quantization part 50.

The entropy decoder 40 of this example decodes the input coded data to generate a quantization index Q, and outputs the generated quantization index to the inverse quantization part 50.

The inverse quantization part 50 generates the inverse quantized value, based on the quantization index inputted from the entropy decoder 40, and outputs the generated inverse quantization value to the inverse transformation part 60.

The inverse transformation part 60 performs a inverse transformation process, based on the inverse quantized value inputted from the inverse quantization part 50, and generates a decoded image.

In the inverse quantization part 50, the inverse quantized value estimation part 500 estimates the inverse quantized value, based on the quantization index inputted from the entropy decoder 40, and outputs the estimated inverse quantized value to the correction part 580. That is, the inverse quantized value estimation part 500 does not always generate a single inverse quantized value for one quantization index value, but may generate plural different inverse quantized values for one quantization index value. In other words, the inverse quantized value estimation part 500 generates one inverse quantized value for each quantization index, but does not necessarily generate the same inverse quantized value, even if the input quantization index values are equal.

The inverse quantized value estimation part 500 of this example calculates the correction coefficient α of the inverse quantized value R corresponding to the quantization block of a target block, based on the quantization index of the target block and the quantization indexes (with the same transformation coefficient kind c) of the blocks around the target block, and outputs the calculated correction coefficient α to the correction part 580.

In the following explanation, the correction coefficient α corresponding to each transformation coefficient kind c and each quantization index q is denoted as αycq. Also, the number of signals with the transformation coefficient kind c and each quantization index q is K, and each correction coefficient is denoted as αycq(k) (where k=1,2, . . . ,K).

The distribution estimation part 520 estimates a distribution of transformation coefficient (original data), based on plural quantization indexes (or their associated quantization values) inputted from the entropy decoder 40, and outputs the distribution data indicating the estimated distribution of transformation coefficient to the expected value estimation part 540 and the random number generator 560.

The distribution estimation part 520 of this example calculates a frequency distribution of quantization index value for every transformation coefficient kind c, and generates the distribution data for every transformation coefficient kind c, based on the calculated frequency distribution.

The expected value estimation part 540 calculates the expected value of quantization value, based on the distribution data inputted from the distribution estimation part 520, and outputs the calculated expected value and the distribution data to the correction part 580.

More specifically, the expected value estimation part 540 calculates the expected value of probability density function of original data in every quantization interval, based on the distribution data generated for every transformation coefficient kind c.

The expected value where the transformation coefficient kind is c and the quantization index Q(c,i,j)=q is denoted as E(αTcq). That is, the expected value E(αTcq) is the estimated expected value of a difference between the quantization value R corresponding one to one to the quantization index and the original transformation coefficient T corresponding to this quantization index.

The random number generator 560 generates the random number according to the distribution data inputted from the distribution estimation part 520, and outputs the generated random number to the quantization value output part 590.

The correction part 580 corrects the inverse quantized value (correction coefficient α of inverse quantized value in this example) inputted from the inverse quantized value estimation part 500 in accordance with the distribution data or expected value inputted from the expected value estimation part 540.

Also, the correction part 580 corrects the inverse quantized value (correction coefficient α of inverse quantized value in this example) inputted from the inverse quantized value estimation part 500 to fall within a prescribed range (e.g., the quantization interval corresponding to the quantization index in the case of the inverse quantized value), and outputs the corrected inverse quantized value (correction coefficient α) to the inverse quantized value output part 590.

The correction part 580 of this example corrects the correction coefficient α inputted from the inverse quantized value estimation part 500, based on the expected value inputted from the expected value estimation part 540, so that the frequency distribution of quantization index calculated by the distribution estimation part 520 and the frequency distribution of inverse quantized value calculated by the inverse quantized value estimation part 500 may be almost coincident for every transformation coefficient kind c and in every quantization interval, and linearly corrects the corrected correction coefficient α to fall within a range from −0.5 to 0.5 in accordance with the JPEG method.

The linear correction by the correction part 580 is implemented by selecting the maximum value αmax and the minimum value αmin from among the correction coefficients corresponding to the same quantization index, and linearly transforming the correction coefficient α as a whole, so that the selected maximum value αmax and the minimum value αmin may fall within a prescribed range (from −0.5 to 0.5 in accordance with the JPEG), for example.

If the correction coefficient α is beyond the range from −0.5 to 0.5, the correction part 580 may set the correction coefficient α at a boundary value of this range. Also, the correction part 580 may set α at 0, if the correction coefficient α is beyond the range from −0.5 to 0.5.

Also, the JPEG2000 method is only different from the JPEG method in the range of correction coefficient α. That is, with the JPEG2000 method, the correction part 580 corrects the correction coefficient α in the range where 0≦r+α≦1 is satisfied if Q(c,i,j)>0, the range where −1≦−r+α≦0 is satisfied if Q(c,i,j)<0, and the range where −1≦α≦1 is satisfied if Q(c,i,j)=0.

The inverse quantized value output part 590 decides the inverse quantized value to be applied, employing the inverse quantized value (correction coefficient α of inverse quantized value in this example) inputted from the correction part 580 and the random number inputted from the random number generator 560, and outputs the decided inverse quantized value to the inverse transformation part 60.

The inverse quantized value output part 590 of this example calculates the inverse quantized value, based on the correction coefficient a inputted from the correction part 580 or the random number generator 560 and the quantization index (its associated inverse quantized value). More specifically, the inverse quantized value output part 590 calculates the inverse quantized value Ry(c,i,j) to be applied in accordance with the following expression.
Ry(c,i,j)={Q(c,i,j)+α(c,i,j)}×D(c)

That is, the decoding program 5 of this example does not apply the random number generated by the random number generator 560 as the inverse quantized value itself, but applies the random number generated by the random number generator 560 as the correction coefficient α of the inverse quantized value.

[Distribution Estimation Part]

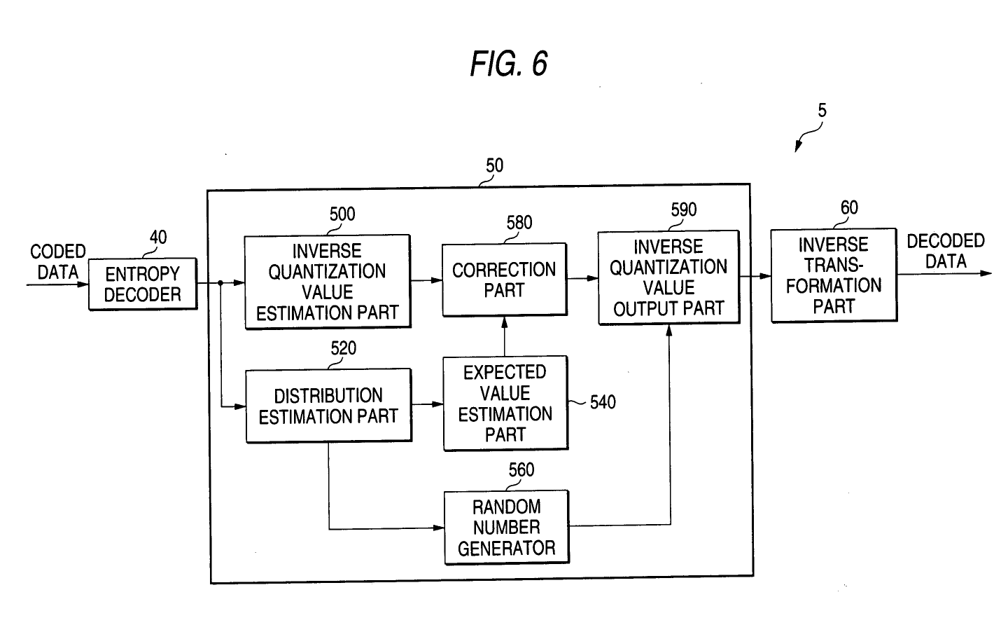

FIG. 7 is a diagram for explaining the distribution estimation part 520 (FIG. 6) in more detail.

As illustrated in FIG. 7, the distribution estimation part 520 includes a zero determination part 522, a non-zero transformation coefficient distribution estimation part 524 and a zero transformation coefficient distribution estimation part 526. The non-zero transformation coefficient distribution estimation part 524 has a function of the distribution estimation device 2 according to the first embodiment.

In the distribution estimation part 520, the zero determination part 522 classifies the quantization index inputted from the entropy decoder 40 according to the attribute (e.g., transformation coefficient kind) of original data corresponding to the quantization index, and determines whether or not the frequency distribution of original data can be estimated only with the group of quantization indexes classified into each attribute (in other words, whether or not the frequency distribution is required to be estimated employing the correlation with the group of quantization indexes classified into other attributes).

The zero determination part 522 of this example determines whether the quantization index inputted from the entropy decoder 40 corresponds to the zero transformation coefficient or the non-zero transformation coefficient, and outputs the quantization index determined corresponding to the non-zero transformation coefficient to the non-zero transformation coefficient distribution estimation part 524, or instructs the zero transformation coefficient distribution estimation part 526 to perform the distribution estimation process for the quantization index determined corresponding to the zero transformation coefficient, employing the distribution of non-zero transformation coefficient.

Herein, the non-zero transformation coefficient means the transformation coefficient in which any of the quantization indexes of the transformation coefficient kind c is not zero. Also, the zero transformation coefficient means the transformation coefficient in which all the quantization indexes of the transformation coefficient kind c are zero. In other words, the transformation coefficient that is not the zero transformation coefficient is the non-zero transformation coefficient.

The non-zero transformation coefficient distribution estimation part 524 estimates the frequency distribution of original data (transformation coefficient in this example), based on the quantization index inputted from the zero determination part 522.

More specifically, the non-zero transformation coefficient distribution estimation part 524 generates the frequency distribution of the quantization index group (plural quantization indexes corresponding to the same transformation coefficient c in this example) having the same attribute, and produces the probability density function of quantization index, based on the generated frequency distribution of quantization index. This probability density function is approximate to the probability density function of transformation coefficient.

The non-zero transformation coefficient distribution estimation part 524 of this example produces the histogram hc(q) of the quantization index Q(c,i,j) (corresponding to the non-zero transformation coefficient) inputted from the zero determination part 522 for every transformation coefficient kind c.

The non-zero transformation coefficient distribution estimation part 524 of this example approximates the produced histogram hc(q) with the Laplace distribution, and provides this Laplace function as the distribution function of transformation coefficient T.

The Laplace distribution is represented as follows.

$$[ Formula 9 ] \\ L ( x ) = \frac{1}{\sqrt{2} σ} exp ( \frac{- \sqrt{2} \vert x \vert}{σ} ) \qquad ( Expression 9 )$$

The non-zero transformation coefficient distribution estimation part 524 obtains the distribution function of transformation coefficient T by calculating σ in the above expression.

First of all, the non-zero transformation coefficient distribution estimation part 524 normalizes the produced histogram hc(q) with the width D(c) of quantization interval and the total number of quantization indexes into the probability density function fhc(x). More specifically, the non-zero transformation coefficient distribution estimation part 524 transforms the histogram hc(q) into the probability density function fhc(x) in accordance with the following expression.

$$[ Formula 10 ] \\ fhc ( x ) = \frac{hc ( q )}{D ( c ) \times {\sum }_{q} hc ( q )} \qquad ( Expression 10 )$$

However, (q−0.5)×D(c)<×≦(q+0.5)×D(c).

The non-zero transformation coefficient distribution estimation part 524 calculates the Laplace function approximating the histogram hc(q).

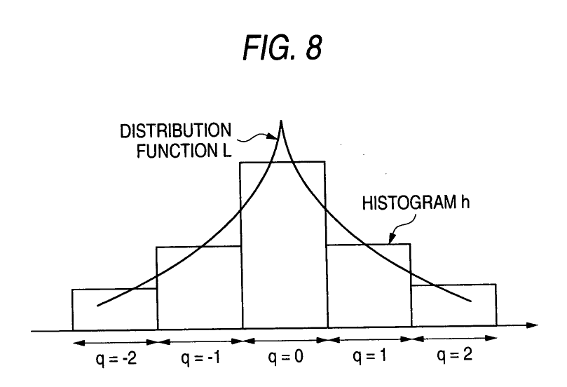

FIG. 8 is a diagram illustrating the histogram h and the distribution function L (Laplace function).

The non-zero transformation coefficient distribution estimation part 524 may obtain σ to make a difference (area difference in this example) between the Laplace function L (x) and the histogram fhc(x) as small as possible, as shown in FIG. 8.

As a function of evaluating “the difference as small as possible”, the following error function Err(σ) is defined.

$$[ Formula 11 ] \\ Err ( σ ) = {\sum }_{q} \vert {\int }_{( q - 0.5 ) \times D ( c )}^{( q + 0.5 ) \times D ( c )} \{ L ( x ) - fhc ( x ) \} ⅆ x \vert \qquad ( Expression 11 )$$

This error function Err is obtained by adding the absolute value of area difference with the probability density function obtained for every quantization index q. As the value of Err(σ) is smaller, the histogram fhc(x) and the Laplace function L(x) are more similar. The non-zero transformation coefficient distribution estimation part 524 may obtain σ to minimize the error function Err(σ) by performing the numerical computation.

The zero transformation coefficient distribution estimation part 526 estimates the frequency distribution of zero transformation coefficient, based on the frequency distribution of other transformation coefficients (non-zero transformation coefficients) estimated by the non-zero transformation coefficient distribution estimation part 524, upon an instruction from the zero determination part 522.

That is, the non-zero transformation coefficient distribution estimation part 524 can estimate the distribution only if the histogram has a meaningful shape, but can not estimate the shape of distribution, if the histogram in which all the frequency values are zero is produced.

Thus, the zero transformation coefficient distribution estimation part 526 estimates the shape of Laplace distribution where all the quantization indexes of the transformation coefficient kind c are zero, employing the already obtained other distribution data (σ value in this example), by the following method.

In this example, since the decoding process with the JPEG method has been described as the specific example, the transformation coefficient kinds are arranged on the two-dimensional matrix of 8×8.

Herein, the σ values are associated with (1,1) component to (8,8) component of DCT coefficients and arranged two-dimensionally, as shown in FIG. 2A. That is, the σ value corresponding to the transformation coefficient of (x,y) component is represented as σ(x,y).

For example, σ(1,1) is the σ value of DC component, and σ(8, 8) is the σ value of transformation coefficient indicating the AC component in the highest frequency range. However, the non-zero transformation coefficient distribution estimation part 524 and the zero transformation coefficient distribution estimation part 526 of this example can not approximate the σ value corresponding to DC component with the Laplace distribution, and are not employed to estimate the σ value.

In this example, σ(x,y) is considered as the function on the xy plane. The zero transformation coefficient distribution estimation part 526 decides this function σ(x,y), employing the already obtained σ value (i.e., σ value calculated by the non-zero transformation coefficient distribution estimation part 524) and estimates the C value corresponding to the zero transformation coefficient.

Specifically, the zero transformation coefficient distribution estimation part 526 specifies the function σ(x,y) and calculates the σ value corresponding to the zero transformation coefficient by applying the distribution estimation method as described in the first embodiment or its modified example.

[Overall Operation]

The overall operation of the decoding device 3 (decoding program 5) will be described below.

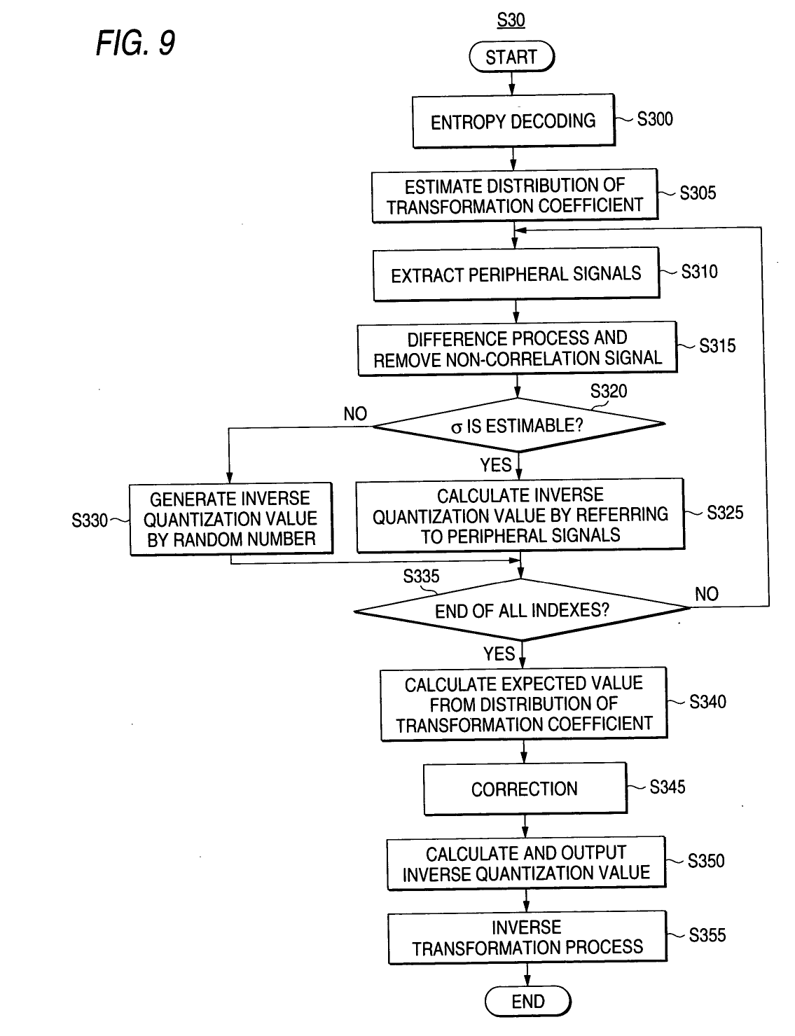

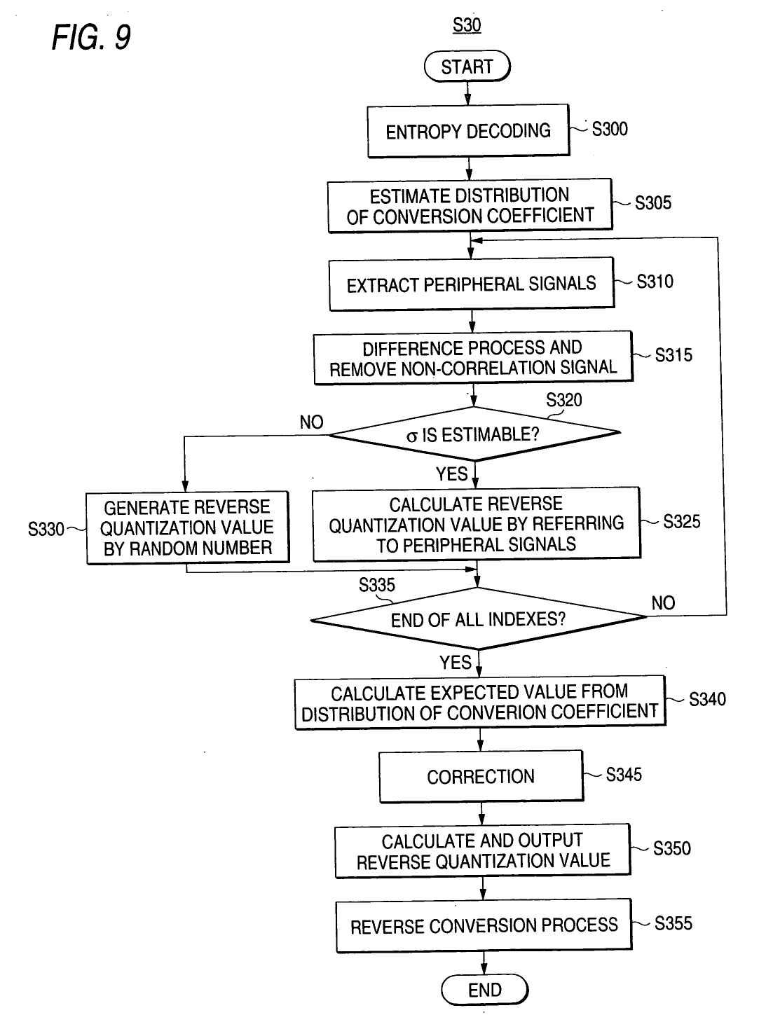

FIG. 9 is a flowchart showing the decoding process (S30) by the decoding program 5 (FIG. 4). In this example, a specific example in which the coded data (with the JPEG method) of image data is inputted will be described below.

As shown in FIG. 9, at step 300 (S300), the entropy decoder 40 (FIG. 6) decodes the input coded data to generate the quantization index of each block (8×8 block), and outputs the generated quantization index of each block to the inverse quantization part 50.

At step 305 (S305), the distribution estimation part 520 estimates the distribution of transformation coefficient T for every transformation coefficient kind, based on plural quantization indexes inputted from the entropy decoder 500.

Specifically, if the quantization index corresponding to one page of image is inputted from the entropy decoder 40, the zero determination part 522 (FIG. 7) provided in the distribution estimation part 520 classifies the input quantization index according to the transformation coefficient kind c, and determines whether the classified quantization index group corresponds to the zero transformation coefficient or the non-zero transformation coefficient.

The non-zero transformation coefficient distribution estimation part 524 (FIG. 7) produces the histogram hc(q) (i.e., histogram for each transformation coefficient kind c) of the quantization index value for each quantization index group corresponding to the non-zero transformation coefficient, and calculates the Laplace function L (i.e., σ value) approximating this histogram hc(q).

Also, the zero transformation coefficient distribution estimation part 526 (FIG. 7) estimates the frequency distribution (i.e., σ value) of zero transformation coefficient, employing the frequency distribution calculated by the non-zero transformation coefficient distribution estimation part 524 through the estimation process (S10 or S20) as shown in FIGS. 4 or 5.

At step 310 (S310), the inverse quantization part 50 (FIG. 6) sets the input quantization index to the target quantization index in order.

The quantization value estimation part 500 (FIG. 6) extracts the peripheral quantization indexes Q(c,i+m,j+n) (−1≦m≦1, −1≦n≦1 in this example) of the target quantization index Q(c,i,j). The extracted peripheral quantization indexes have the quantization index values corresponding to the same transformation coefficient kind c in the 3×3 blocks around the target block, and constitute a 3×3 matrix.

At step 315 (S315), the quantization value estimation part 500 performs the following arithmetical operation employing the extracted peripheral quantization indexes and the target quantization index to produce a difference matrix P.
P(m,n)=Q(c,i+m,j+n)−Q(c,i,j)

That is, the inverse quantized value estimation part 500 calculates the difference values between the target quantization index value and the peripheral quantization index values.

The inverse quantized value estimation part 500 compares the absolute value |P(m,n)| of each difference value included in the difference matrix P with a threshold TH (e.g., 1), and makes the difference value P(m,n) greater than the threshold TH zero (threshold process). That is, the inverse quantized value estimation part 500 removes the peripheral quantization index value of which the difference from the target quantization index value is greater than the threshold as an uncorrelated signal.

At step 320 (S320), the inverse quantization part 50 (FIG. 6) determines whether the estimation of the inverse quantized value for the target quantization index is possible.

Specifically, the inverse quantization part 50 determines that the estimation of inverse quantized value is impossible, if all the components of the difference matrix P from the target quantization index after the threshold process are zero (e.g., if all the peripheral quantization indexes (quantization indexes of peripheral blocks) are coincident in the value, or if all the peripheral quantization indexes are removed as the uncorrelated signal), or otherwise, determines that the estimation of inverse quantized value is possible.

The inverse quantization part 50 goes to processing at S325 if it is determined that the estimation of inverse quantized value (estimation of correction coefficient α in this example) is possible, or goes to processing at S330, if it is determined that the estimation is impossible.

At step 325 (S325), the inverse quantized value estimation part 500 makes the convolution operation for the difference matrix P after the threshold process, employing a 3×3 filter kernel K(m,n), and calculates the correction coefficient αycq. Therefore, if the target quantization index value is equal but the peripheral quantization indexes existing around it are different, the calculated correction coefficients αycq are different from each other.

The filter applied herein has a low pass characteristic.

At step 330 (S330), the random number generator 500 generates the random number according to the distribution data inputted from the distribution estimation part 520 for the target quantization index, and outputs the generated random number as the correction coefficient α to the inverse quantized value output part 590.

Specifically, the random number generator 560 selects the distribution corresponding to the target quantization index out of the distribution estimated by the non-zero transformation coefficient distribution estimation part 524 and the zero transformation coefficient distribution estimation part 526, generates the random number according to the selected distribution, and outputs the random number as the correction coefficient α to the inverse quantized value output part 590.

At step 335 (S335), the inverse quantization part 50 determines whether or not the correction coefficient α is generated for all the quantization indexes. If the correction coefficient α is generated for all the quantization indexes, the procedure goes to processing at S340, or otherwise, goes back to processing at S310 to deal with the next quantization index as the target quantization index.

At step 340 (S340), the expected value estimation part 540 calculates the expected value E(αTcq) of probability density function for each combination of transformation coefficient kind and quantization index, based on the distribution data inputted from the distribution estimation part 520, and outputs the calculated expected value E(αTcq) to the correction part 580.

At step 345 (S345), the correction part 580 classifies the correction coefficients α calculated by the inverse quantized value estimation part 500 according to the transformation coefficient kind and the quantization index, and calculates the minimum value, maximum value and mean value of the classified correction coefficients α.

The correction part 580 compares the expected value E(αTcq) inputted from the expected value estimation part 540 with the calculated mean value for each combination of transformation coefficient kind and quantization index, and shifts the correction coefficient group αycq classified according to the combination of transformation coefficient kind and quantization index so that they may be coincident (shift correction).

Moreover, the correction part 580 determines whether or not the group of correction coefficient α subjected to shift correction falls in a range from −0.5 to 0.5. If not, the range correction for correcting the range of correction coefficient group αycq within the range from −0.5 to 0.5 is made without changing the mean value of correction coefficient group αycq.

At step 350 (S350), the inverse quantized value output part 590 (FIG. 6) calculates the inverse quantized value Ry to be applied, based on the target quantization index Q and the correction coefficient α inputted from the correction part 580 or the correction coefficient α inputted from the random number generator 560, and outputs the calculated inverse quantized value Ry to the inverse transformation part 60.

Specifically, the inverse quantized value output part 590 of this example calculates the inverse quantized value RY by making the following arithmetical operation.
Ry(c,i,j)={Q(c,i,j)+α(c,i,j)}×D(c)

At step 355 (S355), the inverse transformation part 60 (FIG. 6) performs the inverse transformation process (inverse DCT in this example), employing the inverse quantized value (approximate transformation coefficient) inputted from the inverse quantization part 50 to generate the decoded image H by performing the inverse transformation process (inverse DCT in this example).

As described above, the decoding device 3 of this embodiment estimates the distribution of transformation coefficient, based on the quantization index, generates the random number according to the estimated distribution, and generates the inverse quantized value based on the random number.

Also, the decoding device 3 of this embodiment corrects the inverse quantized value so that the distribution (expected value) of transformation coefficient estimated based on the quantization index and the frequency distribution of applied inverse quantized value may be almost coincident.

Thereby, the decoded image is expected to be more reproducible.

[Hardware Configuration]

The hardware configuration for the distribution estimation device 2 of the first embodiment and the decoding device 3 of the second embodiment will be described below.

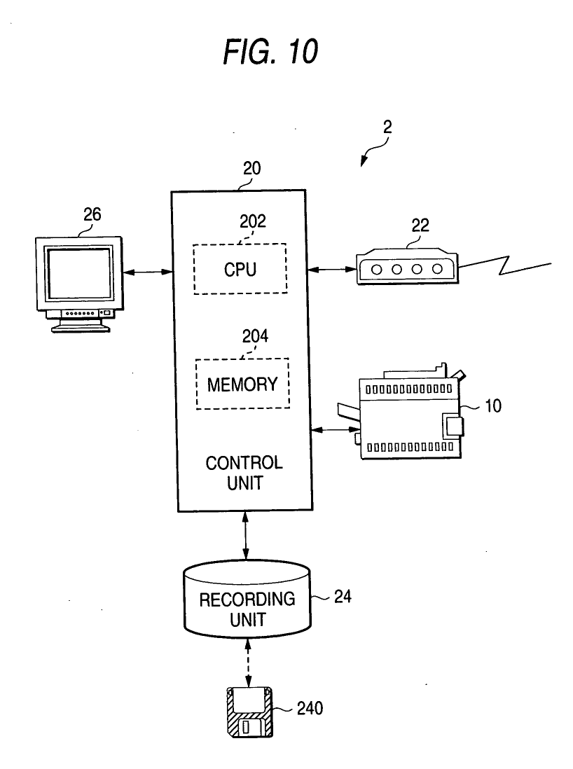

FIG. 10 is a diagram showing the hardware configuration for the distribution estimation device 2 and the decoding device 3 to which the distribution estimation method of the invention is applied around the control device 20.

As shown in FIG. 10, the distribution estimation device 2 and the decoding device 3 include the control device 20 having a CPU 202 and a memory 204, the communication device 22, the recording device 24 such as HDD or CD unit, an LCD display device or a CRT display device, and a user interface unit (UI unit) 26 having a keyboard or touch panel.

Also, the decoding device 3 may be a general-purpose computer with the decoding program 5 installed, which acquires the coded data via the communication device 22 or recording device 24, decodes the acquired coded data and outputs it.

Suitably, the signal is a transformation coefficient generated through a transformation encoding process, and the component is a kind of each transformation coefficient, wherein the distribution data of transformation coefficient for other transformation coefficient kinds is acquired, the acquired distribution data for other transformation coefficient kinds is approximated with a function, and the distribution data of transformation coefficient for the target transformation coefficient kind is calculated employing this function.

Suitably, the transformation coefficient kind is defined by two variables, and the distribution data for other transformation coefficient kinds is approximated with an exponential function in which one output variable is defined by two input variables.

Suitably, partial distribution data is excluded out of the distribution data for other transformation coefficient kinds, the distribution data with partial distribution data excluded is approximated with a function, and the distribution data of transformation coefficient for the target transformation coefficient kind is calculated employing this function.

Suitably, the partial data that should be excluded is decided so that the rank of a matrix for calculating the coefficients of a function used for the approximation may be 3 or greater as a result of excluding the partial distribution data.

Suitably, the partial distribution data among the distribution data for other transformation coefficient kinds is multiplied by a prescribed weighting factor, the distribution data for other transformation coefficient kinds, including the distribution data multiplied by the weighting factor, is approximated with a function, and the distribution data of transformation coefficient for the target transformation coefficient kind is calculated employing the function.

Suitably, in the distribution data of transformation coefficient arranged on a two dimensional plane, the distribution data is approximated with an exponential function in which one output variable is defined by one input variable, when non-zero coefficient exists in one column or one row alone.

Suitably, in the distribution data of transformation coefficient arranged on a two dimensional plane, when only one non-zero coefficient exists, or when two non-zero coefficients exist and no non-zero coefficient does not exist in one column or one row alone, the distribution data is approximated with an exponential function represented by the prescribed coefficients.

Suitably, the target transformation coefficient kind is transformation coefficient kind in which all the quantization index values are zero, and the other transformation coefficient kinds are the transformation coefficient kinds in which any of quantization index values is not zero.

Suitably, the first distribution generation unit generates the distribution data for the transformation coefficient kind in which all the quantization index values are zero, the second distribution generation unit approximates the distribution data generated by the first distribution unit with an exponential function, and generates the distribution data for the transformation coefficient kind in which all the quantization index values are zero employing the exponential function.

Suitably, the second distribution generation unit allows part of the distribution data for the transformation coefficient kind corresponding to a low frequency component to have less influence on the exponential function than the distribution data for the transformation coefficient kind corresponding to a higher frequency component.

The entire disclosure of Japanese Patent Application No. 2005-088229 filed on Mar. 25, 2005 including specification, claims, drawings and abstract is incorporated herein by reference in its entirety.

What is claimed is:

1. A distribution estimation method that estimates a distribution of signal for each of a plurality of components, comprising:
approximating distribution data indicating a distribution of signal of other component by a function to estimate a distribution of a target component; and
calculating distribution data of the target component with the function based on the approximated process.

2. The distribution estimation method according to claim 1, wherein the signal is a transformation coefficient generated through a transformation encoding process, and the component is a kind of each transformation coefficient, the method further comprising:
acquiring distribution data of a transformation coefficient for other transformation coefficient kind;
approximating the acquired distribution data of other transformation coefficient kind by a function; and
calculating distribution data of transformation coefficient of a target transformation coefficient kind with the function based the approximated process.

3. The distribution estimation method according to claim 2, wherein the transformation coefficient kind is defined by two variables, the method further comprising:
approximating the distribution data of other transformation coefficient kind by an exponential function in which one output variable is defined by two input variables.

4. The distribution estimation method according to claim 2, further comprising:
excluding partial distribution data out of the distribution data of other transformation coefficient kind;
approximating the distribution data with the partial distribution data excluded by a function; and
calculating the distribution data of transformation coefficient of the target transformation coefficient kind with the function based the approximated process.

5. The distribution estimation method according to claim 4, further comprising:
deciding the partial distribution data to be excluded so that a rank of a matrix to calculate a coefficient of a function used for the approximation is 3 or greater as a result of excluding the partial distribution data.

6. The distribution estimation method according to claim 2, further comprising:
multiplying partial distribution data among the distribution data of other transformation coefficient kind by a prescribed weighting factor;
approximating the distribution data of other transformation coefficient kind including the distribution data multiplied by the weighting factor by a function; and
calculating the distribution data of transformation coefficient of the target transformation coefficient kind with the function based on the approximated process.

7. The distribution estimation method according to claim 3, further comprising:
when a non-zero coefficient exists in one column or one row alone in distribution data of transformation coefficient arranged on a two dimensional plane, approximating the distribution data by an exponential function in which one output variable is defined by one input variable.

8. The distribution estimation method according to claim 3, further comprising:
when only one non-zero coefficient exists, or when only two non-zero coefficients exist and no non-zero coefficient exists in one column or one row alone in distribution data of transformation coefficient arranged on a two dimensional plane, approximating the distribution data by an exponential function represented by a prescribed coefficient.

9. The distribution estimation method according to claim 2,
wherein the target transformation coefficient kind is a transformation coefficient kind in which all quantization index values are zero, and
other transformation coefficient kind is a transformation coefficient kind in which any of the quantization index values is not zero.

10. A decoding method comprising:
approximating distribution data indicating a distribution of signal of other component by a function regarding the component to estimate a distribution of a target component;
calculating distribution data of the target component by the function based on the approximated process;
calculating a inverse quantized value by the calculated distribution data of the target component; and
generating decoded data by the calculated inverse quantized value.

11. A decoding device comprising:
a first distribution generation unit that generates distribution data indicating a distribution of data before quantization for any of component based on a frequency distribution of quantization index;
a second distribution generation unit that generates distribution data of other component based on the distribution data generated by the first distribution generation unit; and
a inverse quantized value generation unit that generates a inverse quantized value corresponding to a quantization index based on the distribution data generated by the first distribution generation unit or the distribution data generated by the second distribution generation unit.

12. The decoding device according to claim 11,
wherein the first distribution generation unit generates distribution data of transformation coefficient kind in which all quantization index values are zero,
the second distribution generation unit approximates the distribution data generated by the first distribution unit by an exponential function, and
the second distribution generation unit generates distribution data of the transformation coefficient kind in which all the quantization index values are zero by the exponential function.

13. The decoding device according to claim 12,
wherein the second distribution generation unit allows part of distribution data of transformation coefficient kind corresponding to a lower frequency component to have less influence on the exponential function than distribution data of transformation coefficient kind corresponding to a higher frequency component.

14. A storage medium readable by a computer, the storage medium storing a program of instructions executable by the computer to perform a function for estimating a distribution of signal for each of a plurality of components, the function comprising:
approximating distribution data indicating a distribution of signal of other component by a function regarding the component to estimate a distribution of a target component; and
calculating the distribution data for the target component by the function based on the approximated process.
